(19) United States
(12) Patent Application Publication
(10) Pub. No.: US 2004/0055637 A1
(43) Pub. Date: Mar. 25, 2004

(54) Vacuum rescue devices, systems, and methods

(76) Inventors: Bernie Jon Bossom, Streator, IL (US); Carl James Woods, Ottawa, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/667,765

(22) Filed: Sep. 22, 2003

Related U.S. Application Data
(60) Provisional application No. 60/412,534, filed on Sep. 21, 2002.

(51) Int. Cl. F16K 17/14

(52) U.S. Cl. 137/114

(57) ABSTRACT

The invention provides a vacuum safety valve for a vacuum system that can be used for debris collection, and which is especially useful in trench rescue. Under predetermined vacuum level conditions (e.g., when the airflow path of a vacuum system is blocked by an obstruction), the safety valve is designed to automatically open radial ports around the circumference of the safety valve. When the radial ports are opened, the vacuum level in the vacuum system between the obstruction and the safety valve is at least significantly reduced thereby preventing full vacuum from acting on the obstruction. In a preferred aspect, the safety valve further comprises a manual vacuum release such that an operator can trip the release and reduce the vacuum level in a vacuum system comprising the safety valve. The invention also provides a related vacuum system and/or vacuum rescue system including additional elements and methods of debris removal using the inventive systems and nozzles.

### CROSS-REFERENCE TO RELATED PATENT APPLICATIONS

This patent application claims the benefit of U.S. Provisional Patent Application No. 60/412,534, filed Sep. 21, 2002.

### FIELD OF THE INVENTION

This invention pertains to vacuum systems for rescuing objects and animals, particularly humans, entrenched in debris. More specifically, the invention pertains to a vacuum safety valve and a vacuum system comprising the same.

### BACKGROUND OF THE INVENTION

Trench-forming soil excavation work is one of the most common activities in the construction industry. The trench walls formed in such excavation often become destabilized. Soil in the trench walls may not be able to support its weight and the weight of the soil above. When a breaking point is reached, one or both of the trench walls collapse, often with workers in the trench.

The Occupational Safety and Health Administration, (OSHA), states that accidents in excavation work occur more frequently than accidents in construction in general. OSHA also states that trench cave in accidents are much more likely to result in fatalities then other construction related accidents, and that the fatality rate for trench work is estimated to be as high as 112 percent greater than the rate for construction in general. Remarkably, it is estimated that 65% of deaths from trench cave-ins are would-be rescuers.

Trench rescue operations are complex, time consuming, labor-intensive operations, and pose a number of hazards for rescuers and victims including the possible cave in of surrounding soil, hazardous atmospheric conditions, and utility hazards. Secondary collapse, during shoring of an intact portion of a trench wall, is another potential hazard.

Traditionally, trench rescue operations consists of a number of rescuers using hand tools, such as small hand shovels, hand trowels, or post hole diggers. Significant trench collapse incidents may result in the total burial of victim(s), which will require rescuers to remove a great deal of soil during extrication. Time is of the essence in such situations, but the process or removing the soil or debris can be very time consuming and labor intensive for rescuers. Such operations also put a number of rescue workers into close proximity with the above-mentioned hazards.

To address the shortcomings associated with traditional trench rescue techniques, rescue services have recently used mechanical vacuum devices to speed the debris removal process. While more effective at rapidly removing debris than traditional methods, the use of such vacuum systems pose a number of hazards to victim(s) and rescuers. Primary among such problems is that the high vacuum applied by such systems to remove debris can cause significant injury or death when the vacuum nozzle contacts the victim. Particularly when a victim is covered by soil or debris, the risk of such undesirable contact is significant. The poor footing often present at the trench site, and errors in judgment by the operators of the vacuum hose, compound these risks. Additionally, once the high power vacuum contacts a victim's body, it can be difficult for the user to release the body from the vacuum in time to prevent injury, and it can also be difficult to prevent the vacuum from contacting the body while attempting to free the body part. Even if the associated vacuum-generating device has a safety release, it will often take too long for the release to engage without causing significant injury to the victim.

For these and other reasons, there remains a need for improved and alternative vacuum system rescue/extraction devices, vacuum rescue/extraction systems including such devices, and related methods for vacuum excavation and rescue. These and other advantages of the invention, as well as additional inventive features, will be apparent from the description of the invention provided herein.

### BRIEF SUMMARY OF THE INVENTION

In one aspect, the invention provides a vacuum safety valve that is designed to automatically open radial port(s) around the circumference of the valve when the pressure within the safety valve falls below a predetermined level, which predetermined level typically and preferably is indicative of an obstruction in the airflow path through a vacuum system comprising the safety valve of the invention. When the radial port(s) are opened, the vacuum level within the vacuum system is reduced, thereby preventing full vacuum from contacting the obstruction. In a preferred aspect, the safety valve further comprises a manual vacuum release such that an operator can trip the release and reduce the vacuum level in a vacuum system comprising the safety valve.

In another aspect, the invention provides a vacuum rescue system comprising a safety valve as described above in airflow communication with a vacuum hose and a vacuum-generating device. The vacuum rescue system can further comprise one or more devices for fluidizing or loosening the soil/debris at a target site (e.g., an air knife).

The invention also provides a method of safely removing debris or soil from an excavation site that includes the use of the above-described systems and nozzles. The methods of the invention are characterized in requiring less manpower and being safer than the use of current commercially available vacuum systems.

### BRIEF DESCRIPTION OF THE DRAWINGS

FIG. 1 is a perspective view of a vacuum safety valve according to the teachings of the invention.

FIG. 2 is a perspective, sectional view of the vacuum safety valve depicted in FIG. 1 in which the inner and outer sleeves are in the second, vented position.

FIG. 3 is a perspective, sectional view of the vacuum safety valve depicted in FIG. 1 in which the inner and outer sleeves are in the first, closed position.

FIG. 4 is a perspective, sectional view of a vacuum safety valve according to the teachings of the invention in which the inner and outer sleeves are in the second, vented position and the valve comprises a manual vacuum relief assembly.

FIG. 5 is a perspective view of a vacuum system comprising a vacuum safety valve according to the teachings of the invention.

FIG. 6 is a perspective view of a vacuum safety valve according to the teachings of the invention in the first, closed position in which the safety valve further comprises a catch mechanism and is provided in a vacuum nozzle configuration.

### DETAILED DESCRIPTION OF THE INVENTION

The invention provides a vacuum safety valve for use with vacuum systems and/or vacuum rescue/excavation systems, specialized vacuum rescue/excavation systems comprising the safety valve of the invention, and related methods of rescuing an object or animal, usually at least one human victim, which is at least partially covered, enclosed, and/or trapped within debris, soil, or other material.

In one exemplary aspect, the invention provides a vacuum safety valve for a vacuum system comprising an interior chamber and at least one responsively openable radial port located around the circumference of the safety valve. In operation, the radial ports are at least substantially closed such that the safety valve is at least substantially airtight and a vacuum applied to the safety valve will result in a vacuum (e.g., a decrease in pressure) in the interior chamber. The safety valve can be of any suitable size and made of any suitable materials. The size of the safety valve is selected so as to engage a vacuum hose that communicates with a vacuum-generating device (e.g., a vacuum truck comprising a positive displacement (PD) blower vacuum generator or fan vacuum generator, a skid-mounted vacuum-generating device, a stationary vacuum-generating device, a vacuum system trailer, or other mobile vacuum device or system). The safety valve typically is made of durable materials, such as steel, aluminum, rigid alloys, durable plastics, or other material(s) that are able to withstand the vacuum to which the safety valve may be subjected (e.g., about 92 kPa (about 27 inches of mercury)—which is a typical vacuum for a PD blower vacuum truck).

The safety valve automatically opens at least one radial port when the vacuum level within the safety valve (e.g., within the interior chamber of the safety valve) rises above a predetermined level. Typically, the predetermined vacuum is selected to correspond to a vacuum level indicative of an obstruction in the airflow path through a vacuum system comprising the safety valve of the invention. The safety valve can include any suitable number of radial ports of any suitable size. Typically and preferably, the safety valve includes a plurality of such responsively openable radial ports. More preferably still, the opening of the radial port(s)causes a substantial section of the safety valve to be at least about 50% open to airflow from the environment surrounding the safety valve.

The opening of the radial ports is preferably brought about by a mechanical pressure release (ideally a single mechanical release), as opposed to an electronic detector/control system or other more complicated system. For example, in a preferred embodiment, the safety valve comprises two sleeves (e.g., an inner and outer sleeve) in concentric relationship, wherein at least one of the sleeves can move telescopically with respect to the other sleeve. In such an embodiment, each of the sleeves comprises a number of air holes of similar shape. When the safety valve is in a first, closed position (e.g., the safety valve will allow a vacuum to be applied to the interior chamber), the air holes of the individual sleeves are not aligned, and the sleeves are held in a position by a retaining assembly (e.g., a flexible plunger). In this sealed and operational position, the chamber or channel within the sleeves is substantially airtight so that a vacuum can be maintained within the chamber. The retaining assembly is designed so as to yield when the vacuum within the safety valve rises above a predetermined vacuum level. In a particularly preferred aspect, the retaining assembly is designed so as to yield when the vacuum level rises above about 13.7 kPa (i.e., when the absolute pressure within the interior chamber of the safety valve is about 13.7 kPa (about 2 psi) below ambient atmospheric pressure). Thus, for example, when the safety valve is used in a vacuum system to remove debris from a trench rescue site and an object, such as the body part of a victim, blocks the nozzle of the vacuum system, the resulting increase in vacuum within the vacuum system will cause the retaining assembly to yield so that the inner and outer sleeves move relative to each other. When the sleeves move in response to the increased vacuum level within the safety valve, they are adapted to move into a position where the air holes of the inner sleeve and outer sleeve become aligned, so that radial ports are formed, and the vacuum within the interior chamber of the safety valve and the vacuum system is substantially reduced, if not essentially eliminated, thereby allowing the release of the victim's body part (or other object) before injury (or damage) occurs.

In a preferred aspect, the vacuum safety valve of the invention includes a manual vacuum relief assembly. The manual vacuum relief assembly is preferably designed for quick manual release so that the vacuum to the safety valve can be substantially reduced, if not essentially eliminated, when the manual vacuum relief is tripped. The vacuum relief can be any suitable device for this purpose, but typically is a plug that sealingly engages a port of the vacuum safety valve located at a distal end of the safety valve and adapted to communicate with the environment surround the safety valve. The plug is designed to maintain the sealing relationship with the port of the vacuum safety valve unless a user removes the relief by applying a force thereto.

In another aspect, the invention provides a vacuum system comprising a vacuum hose in airflow communication with a vacuum-generating device and one of the inventive safety valves described above. Such a system can include any suitable type of vacuum hose. Eight-inch diameter flexible plastic vacuum hoses, for example, are commonly used for commercial vacuum truck and trailer systems that are useful in debris removal/trench rescue.

In particular aspects, the vacuum system of the invention can include at least two nozzle assemblies. For example, the hose can include a Y-shaped connector that feeds into two vacuum tubes, which preferably are of smaller diameter than the vacuum tube upstream of the Y-shaped connector. A vacuum safety valve of the invention can be positioned upstream (i.e., closer to the vacuum-generating device) or downstream (i.e., farther from the vacuum-generating device) of the Y-shaped connector. Such systems allow more than one rescuer or user to work on a target site simultaneously using only a single vacuum-generating device. This can be particularly advantageous when the system is used in deep trench rescue, so as to avoid secondary collapse.

In a more particular and preferred aspect, the invention provides a vacuum safety valve for a vacuum system that comprises an inner sleeve, an outer sleeve, and a retainer assembly. The inner sleeve comprises an internal channel interior to at least a portion of the inner sleeve. The internal channel of the inner sleeve forms at least a portion of the internal chamber of the safety valve and can be adapted to communicate with a vacuum system. The internal channel of the inner sleeve can also be internal to a portion of the outer sleeve, which portion of the outer sleeve is contiguous with the portion of the inner sleeve surrounding the internal channel. The internal channel permits a vacuum suction force applied at one end of the safety valve to reduce the pressure within the internal channel. The inner sleeve and outer sleeve both include at least one airflow passageway or hole. The inner sleeve can move telescopically (lengthwise) with respect to the outer sleeve over some distance (e.g., about 3 to about 4 inches), such that the total length of the nozzle and internal channel is increased or decreased. The retainer assembly is positioned to contact the inner sleeve and is adapted to maintain the inner and outer sleeves in a first, closed position in which the airflow passageway of the inner sleeve is at least substantially blocked by the outer sleeve so that the internal chamber of the safety valve is substantially airtight.

As the air pressure within the safety valve is decreased below the ambient atmospheric pressure, the lower pressure within the safety valve and the higher atmospheric pressure outside of the safety valve exert a compressive force on the safety valve. When the inner and outer sleeves are provided in an extended telescopic arrangement (i.e., when only a relatively small portion of the inner sleeve is disposed within the outer sleeve), such compressive force acts to telescopically move the inner and outer sleeves in a direction to reduce the volume of the internal chamber formed by the inner and outer sleeves. Thus, when the pressure on the inner and outer sleeves reaches a predetermined level (e.g., when the vacuum level within the safety valve rise above a predetermined level), the retainer assembly yields to the force exerted on the inner and outer sleeves, which is induced by the increased vacuum force in the safety valve, such that the inner and outer sleeves move to a second position. The second position is a vented position, wherein the airflow passageways of the inner and outer sleeves substantially align, thereby forming at least one radial port that allows airflow communication between the environment surrounding the safety valve and the internal chamber of the safety valve. In this respect, when a portion of a vacuum system downstream of a safety valve according to the invention is blocked by an object, such as a victim's body part, the vacuum within the downstream portion of the vacuum system increases to a point where the retainer assembly yields (usually at about 13.7 kPa or more (about 2.0 psi or more) below ambient atmospheric pressure) to the compressive pressure exerted on the inner and outer sleeves. The inner and outer sleeves then move to a second, vented position where the airflow passageways of the inner and outer sleeves align to form at least one radial port, thereby significantly reducing, if not entirely eliminating, the vacuum force downstream of the safety valve and permitting the attached object or body part to be quickly disengaged from the vacuum system.

In order to further explain the invention, representative embodiments of the vacuum safety valve and vacuum system of the invention will be described with reference to the accompanying figures. It will be understood that the provided description of such representative devices and systems is intended merely to further illuminate the invention rather than limit its scope. An ordinarily skilled artisan, given the preceding general description of the invention, will recognize several alternative variations of the representative embodiments described in the following paragraphs and shown in the accompanying figures can be designed and employed in accordance with the invention.

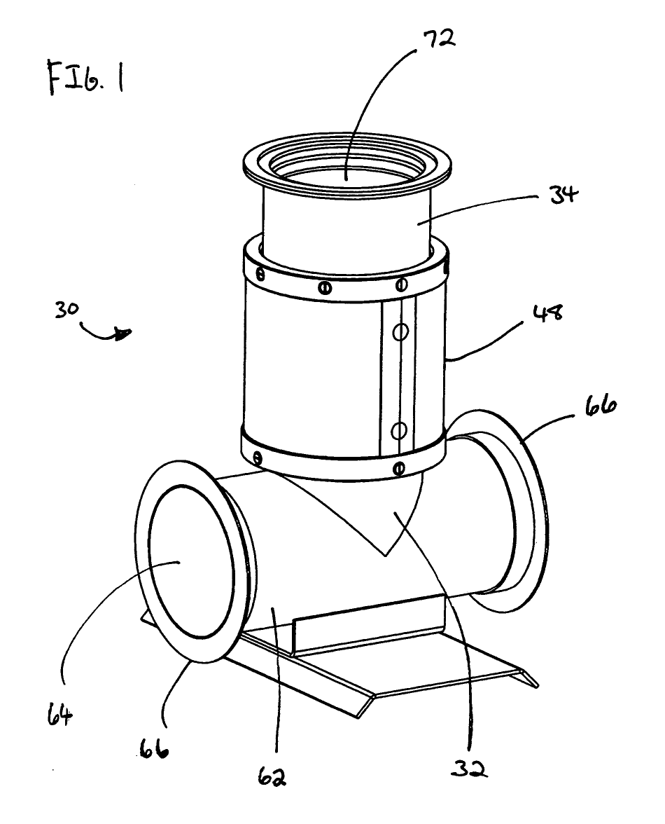

Turning to the accompanying figures, FIG. 1 depicts a preferred embodiment of the vacuum safety valve of the invention. In particular, the vacuum safety valve 30 comprises a cylindrical inner sleeve 32 and a cylindrical outer sleeve 34 in concentric relationship with one another to form an internal chamber within the vacuum safety valve. The vacuum safety valve 30 further comprises a retaining assembly (not pictured), which is positioned to contact at least one of the inner and outer sleeves and adapted to retain the inner and outer sleeves in a first, closed position. While the inner and outer sleeves of the vacuum safety valve depicted in FIG. 1 are cylindrical in shape, the inner and outer sleeves can be provided in any suitable shape. For example, the inner and outer sleeve can have a substantially square or rectangular cross-section. It will be understood that, in order to permit the telescopic movement of the inner and outer sleeves and provide a vacuum safety valve that can be substantially airtight, the cross-section of the inner and outer sleeve should be substantially the same shape.

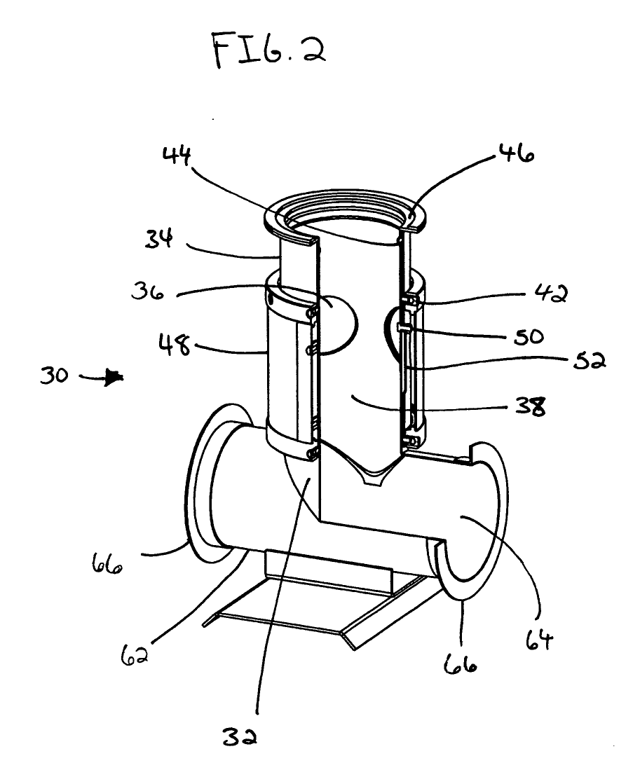

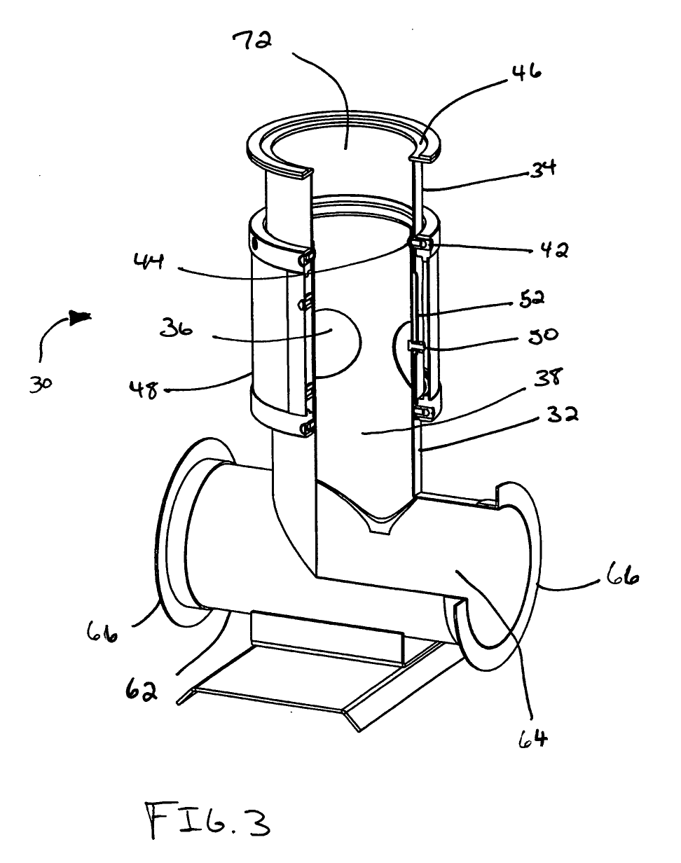

The inner sleeve 32 comprises an airflow passageway 36 and an internal channel 38, which corresponds to the internal chamber of the vacuum safety valve 30. The outer sleeve 34 also comprises an airflow passageway, which is aligned with the airflow passageway 34 of the inner sleeve 32 in the vacuum safety valve 30 depicted in FIG. 2 to form the radial port of the vacuum safety valve 30. In order to arrest the telescopic movement of the inner and outer sleeves when the airflow passageways are substantially aligned to form the radial port of the vacuum safety valve, the outer sleeve 34 can further comprise a lip 46, which, as shown in FIG. 3, protrudes inward past the inner surface of the outer sleeve 34. In such an embodiment, the distal end of the inner sleeve 32 contacts the lip 46 of the outer sleeve 34 when the inner and outer sleeves are in the second, vented position and the airflow passageways of the inner and outer sleeve are substantially aligned, as depicted in FIG. 2.

The retaining assembly of the vacuum safety valve can comprise any suitable device capable of retaining the inner and outer sleeves in the first, closed position until the vacuum within the vacuum safety valve rises above a predetermined level. For example, the retaining assembly can comprise a brake that frictionally engages the inner and/or outer sleeves and applies a force sufficient to resist the telescopic movement of the inner and outer sleeves under normal vacuum (i.e., when the vacuum level within the vacuum safety valve is below the predetermined vacuum level). Preferably, the retaining assembly comprises a spring plunger, more particularly a nylon spring plunger. As depicted in FIG. 2, the inner sleeve 32 preferably comprises a groove 44 on the outer surface of the inner sleeve 32, which groove preferably has sides which are at least partially sloped relative to vertical. The groove 44 is positioned on the outer surface of the inner sleeve 32 such that the groove 44 and retaining assembly 42 engage when the inner and outer sleeves are in the first, closed position. In such an embodiment, the retaining assembly 42 (e.g., the spring plunger) engages the groove 44 on the outer surface of the inner sleeve 32, thereby preventing the telescopic movement of the inner and outer sleeves. The engagement of the groove 44 on the outer surface of the inner sleeve 32 and the retaining assembly 42 is more clearly depicted in FIG. 3, which shows a sectional view of the vacuum safety valve 30 in the first, closed position.

In such an arrangement, the retaining assembly is selected such that it exerts a maximum force on the inner sleeve when it engages the groove, which force is only sufficient to resist the relative telescopic movement of the inner and outer sleeves under normal vacuum conditions (i.e., when no obstruction blocks the airflow through a vacuum system comprising the safety valve). The retaining assembly is further selected such that the portion of the retaining assembly engaging the groove (e.g., the plunger) can easily disengage the groove as the compressive force acting on the inner and outer sleeves increases (e.g., when the vacuum within the internal chamber of the safety valve rises above the predetermined vacuum level). For example, when the retainer assembly comprises a spring plunger, the spring should be selected such that the maximum force is applied to the inner sleeve when the plunger engages the groove in the inner sleeve. Furthermore, the maximum pressure exerted by the spring should only be sufficient to resist the relative telescopic movement of the inner and outer sleeves under normal vacuum conditions. Lastly, the plunger (e.g., the shape and material of the plunger) should be selected such that it can easily move into and out of engagement with the groove on the inner sleeve and the outer surface of the inner sleeve can easily slide along the confronting surface plunger.

As depicted in the accompanying figures, the vacuum safety valve of the invention preferably further comprises a safety screen 48. As can be seen from FIG. 2 and FIG. 3, the safety screen 48 typically is positioned around the outer sleeve 34 so that the radial port of the vacuum safety valve (i.e., the airflow passageway 36 of the inner sleeve 32 and the airflow passageway (not pictured) of the outer sleeve 34) are covered by the safety screen. In such an arrangement, the safety screen helps to prevent large pieces of debris from entering the vacuum safety valve when the safety valve is in the second, vented position. The safety screen also prevents an operator's extremities (e.g., hands, fingers, feet, toes, etc.) from contacting or entering the radial port of the vacuum safety valve, where they could be injured when the safety valve is reset to the first, closed position or they could completely block the radial port and be injured by the force of the vacuum. The safety screen can be constructed of any suitable material, but should include voids of sufficient size and number to allow air to flow from the surrounding environment into the radial port of the vacuum safety valve (i.e., the aligned airflow passageways of the inner and outer sleeves). For example, the safety screen can be constructed of metal hardware cloth (e.g., welded or woven metal hardware cloth), rigid plastic screening, or a sheet of rigid material having a plurality of holes punched in the surface thereof. The safety screen 48 can be attached to the vacuum safety valve 30 in any suitable manner, but preferably is fixedly attached to the outer sleeve 34 using any suitable fastener (e.g., screws).

In order to prevent the rotational movement of the inner and outer sleeves relative to each other, the vacuum safety valve preferably comprises at least one stud that engages and slides within a slot in the inner and/or outer sleeve. As depicted in FIG. 2, the stud 50 can be fixedly attached to the inner sleeve 32 and engage a vertical slot 52 provided in the outer sleeve 34. For example, FIG. 2 and FIG. 3 together depict the vacuum safety valve 30 in the first and second positions and demonstrate how the stud 50 engages the vertical slot 52 in the outer sleeve to allow the telescopic movement of the inner and outer sleeves. Alternatively, the stud can be fixedly attached to the outer sleeve and engage a vertical slot provided in the inner sleeve. In yet another embodiment, a vertical slot can be provided in both the inner and outer sleeves, and the stud can engage both slots and be adapted to slide within them both. In any of the aforementioned embodiments, the stud 50 and slot 52 permit the telescopic movement of the inner sleeve 32 and the outer sleeve 34, while preventing the inner sleeve 32 and the outer sleeve 34 from rotating relative to each other. Prevention of such rotational movement ensures that the airflow passageways of the inner and outer sleeves will substantially align and will remain substantially aligned when the vacuum safety valve switches to the second, vented position.

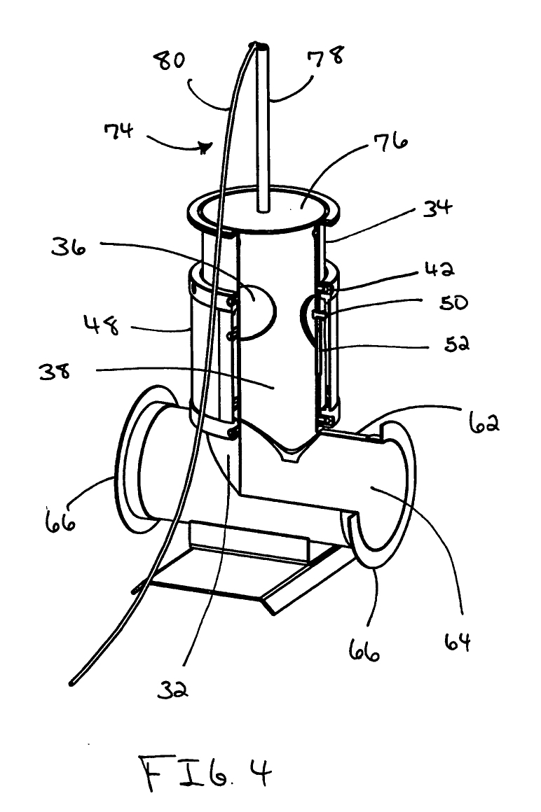

In order to enable an operator to quickly disengage the vacuum in the event that that the vacuum safety valve of the invention fails to switch to the second, vented position, the vacuum safety valve preferably further comprises a manual vacuum relief assembly. The manual vacuum relief assembly can comprise any suitable device that enables the rapid and easy manual venting of the vacuum safety valve to the surrounding atmosphere. As depicted in FIG. 1 and FIG. 3, the outer sleeve 34 can comprise at least one port 72. The port 72 typically is positioned at a distal end of the outer sleeve 34 (e.g., the distal end of the outer sleeve that is not telescopically engaged with the inner sleeve). When the port 72 is open (e.g., when the port is not blocked), the port 72 communicates with the environment surrounding the vacuum safety valve 30 and also allows the internal channel 38 of the inner sleeve 32 and the internal chamber of the safety valve 30 to communicate with the environment surrounding the vacuum safety valve 30. When the outer sleeve 34 is provided with a port 72, the manual vacuum relief assembly can comprise a removable plug that sealingly engages the port 72. Such an embodiment of the manual vacuum relief assembly is depicted in FIG. 4. In particular, the manual vacuum relief assembly 74 comprises a plug 76, and the plug 76 sealingly engages the port (not pictured) provided in the outer sleeve 34. In order to aid in the removal of the plug 76 from the port, the manual vacuum relief assembly 74 can further comprise a rod 78, which is fixedly attached to the plug 76. The rod 78 can act as a handle that provides for the easy removal of the plug 76 by hand, or the rod 78 can be attached to a tether 80. When the tether 80 is pulled, the rod 78 acts as a lever and converts the lateral movement of the tether 80 into a vertical force on the plug 76, thereby removing the plug 76 from the port (not pictured) in the outer sleeve 34 and exposing the internal channel 38 of the inner sleeve 32 and the interior chamber of safety valve 30 to the surrounding atmosphere.

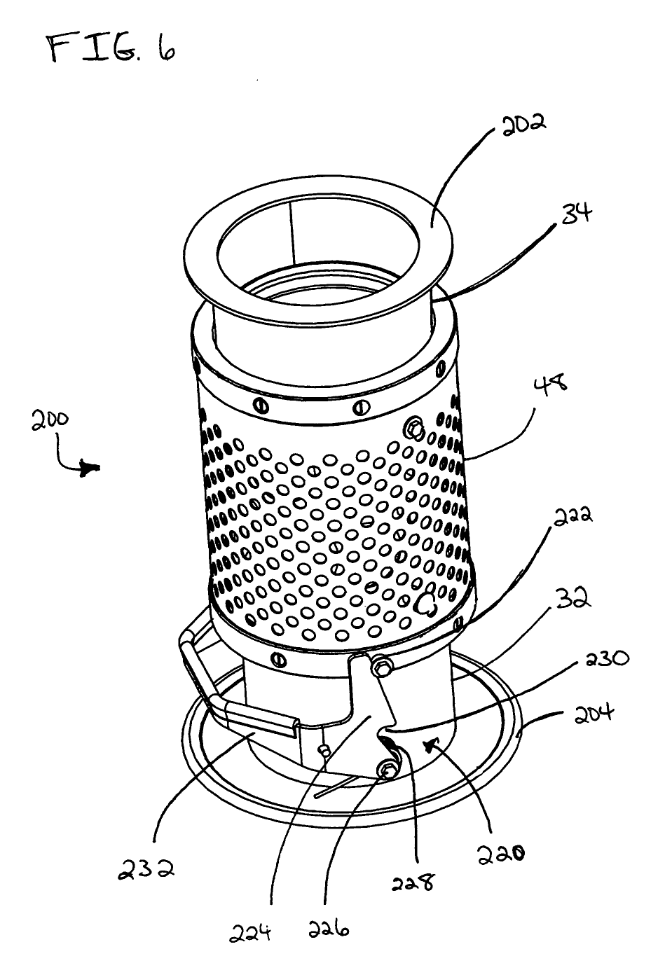

In order to prevent an accidental resetting of the vacuum safety valve (i.e., an accidental movement of the inner and outer sleeves from the second, vented position to the first, closed position), the safety valve can further comprise a catch mechanism. The catch mechanism is positioned to contact at least one of the inner and outer sleeves and is adapted to retain the inner and outer sleeves in the second, vented position until an operator applies a pressure, preferably a significant pressure, to release the inner and outer sleeves and reset the catch mechanism. The catch mechanism can comprise any suitable device capable of retaining the inner and outer sleeves in the second, vented position. For example, the inner sleeve can comprise a second groove on the outer surface of the inner sleeve, which second groove is positioned to engage the retaining assembly when the inner and outer sleeves are in the second, vented position. Alternatively, and as depicted in FIG. 6, the catch mechanism 220 can comprise a pin 222 that is fixedly attached to one of the inner and outer sleeves and a catch hook 224 attached to the other sleeve. In such an embodiment, the catch hook 224 can be mounted to the surface of the sleeve to provide limited rotational movement of the catch hook 224 about an axis 226 that is substantially perpendicular to the surface of the sleeve 32. At least one torsion spring 228 can be positioned to contact the catch hook 224 and adapted to apply a pressure to the catch mechanism 220 in a direction that maintains contact between the pin 222 and the catch hook 224. When the inner and outer sleeves 32,34 move to the second, vented position, the pin 222 slides along the surface of the catch hook 224 until it engages a deep notch 230 provided in the catch hook 224. Typically, the notch 230 is positioned on the catch hook 224 so that the pin 222 engages the notch 230 when the airflow passageways of the inner and outer sleeves are substantially aligned (i.e., when the safety valve is in the second, vented position). Due to the action of the torsion spring 228, a considerable force must be applied to the catch hook 224 to counter the force exerted on the catch hook 224 and rotate the catch hook 224 so that the pin 222 can be unseated from the notch 230 and the sleeves 32,34 returned to the first, closed position. To assist the operator in releasing the pin 222 from the catch hook 224, a lever 232 can be attached to the catch hook, which lever is used to convert a downward pressure on the lever 232 into a rotational movement of the catch hook 224 about the axis 226.

A vacuum safety valve according to the invention can be provided in any configuration. As depicted in the accompanying figures, a vacuum safety valve according to the invention can be provided as a substantially T-shaped section. For example, as depicted in FIG. 2, the inner sleeve 32 of the vacuum safety valve 30 can be transversely or perpendicularly attached to a cylindrical tube 62 comprising a cylindrical channel 64 therein. The inner sleeve 32 and cylindrical tube 62 form a substantially T-shaped section in which the internal channel 38 of the inner sleeve 32 communicates with the cylindrical channel 64 of the cylindrical tube 62. Such an arrangement allows the internal chamber of the safety valve 30 to communicate with a vacuum system (not pictured) attached to the cylindrical tube 62, while preventing any soil or debris traveling through the vacuum system or the cylindrical tube 62 from entering the internal chamber of the safety valve 30, where it could interfere with the proper functioning of the safety valve. In order to aid in attaching the safety valve 30 and cylindrical tube 62 to a suitable vacuum system, one or more flanges 66 can be attached to the distal ends of the cylindrical tube 62 (i.e., the ends of the cylindrical tube farthest removed from the connection with the inner sleeve).

Alternatively, the vacuum safety valve can be provided as a vacuum nozzle. In particular, as depicted in FIG. 6, the vacuum safety valve 200 can be configured such that one of the inner and outer sleeves is adapted to connect to a vacuum hose. The inner or outer sleeve can be adapted to connect with the vacuum hose in any suitable manner, but preferably the sleeve comprises a flange to which the vacuum hose is coupled by a clamp (e.g., a “quick clamp”). Preferably, and as depicted in FIG. 6, the outer sleeve 34 comprises a connection flange 202 that enables the outer sleeve to be connected to a vacuum hose (not pictured). The other sleeve (i.e., the sleeve not adapted to connect to a vacuum hose) comprises a suction port in airflow communication with the environment surrounding the vacuum safety valve. As depicted in FIG. 6, the inner sleeve 32 comprises a suction port (not pictured) which permits airflow communication with the environment surround the vacuum safety valve 200. The suction port can have any suitable size and/or configuration, but typically is configured to maximize the vacuum level at the suction port while also allowing the material (e.g., debris or soil) to pass through the suction port and vacuum safety valve and into the vacuum system (e.g., vacuum hose). For example, the diameter of the suction port can be slightly greater than the diameter of the internal chamber of the safety valve, which can make the safety valve act as a venturi and improve the dynamics of the airflow entering the safety valve. As depicted in FIG. 6, the suction port (not pictured) can also be covered with a casing 204 (e.g., a foam or rubber casing) to protect objects from injury due to contact with the suction port. In such an embodiment, when the inner and outer sleeves are in the first, closed position, the gases flowing into the vacuum safety valve through the suction port convey the material (e.g., debris or soil) through the safety valve and into the vacuum system (e.g., vacuum hose). Furthermore, when an obstruction (e.g., an object or victim's body part) partially or completely blocks the suction port and causes the vacuum level within the safety valve to rise above the predetermined vacuum level, the radial port(s) of the vacuum safety valve opens (e.g., the inner and outer sleeves move to the second, vented position), thereby reducing the vacuum level within the safety valve and permitting the obstruction to be removed from the suction port.

As noted above, the invention also provides a vacuum system. In its simplest form, the vacuum system of the invention comprises a vacuum safety valve according to the invention and at least one vacuum hose attached thereto. Typically, the vacuum system comprises a vacuum safety valve according to the invention and two vacuum hoses attached to the vacuum safety valve.

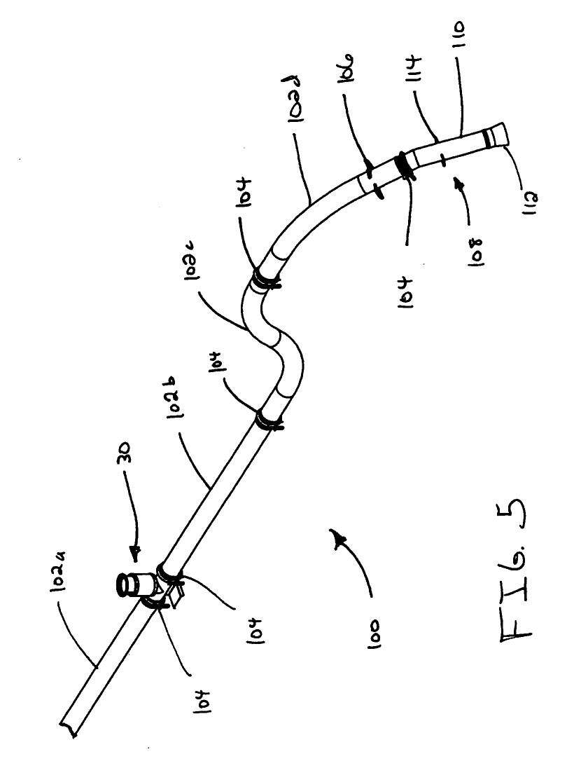

An exemplary vacuum system 100 of the invention is shown in FIG. 5. The vacuum system 100 includes a vacuum safety valve of the invention 30 as described above, which engages the end of a vacuum hose 102a. The other end of the vacuum hose 102a can ultimately be connected to any suitable vacuum-generating device (not pictured), such as such as a vacuum truck, a stationary vacuum system, a vacuum trailer, or other mobile vacuum device. The safety valve 30 typically is also connected to at least one other vacuum hose 102b, which can be connected to additional hoses 102c, 102d to provide a vacuum system having any suitable length. The vacuum hoses can be connected to the safety valve and each other by any suitable means. Typically, the vacuum hoses 102 and safety valve 30 are connected using a connector 104. The connector 104 can be any suitable device capable of providing a sealed connection between the safety valve and vacuum hoses. Preferably, the connector 104 comprises a sealing clamp, such as the latch-type “quick clamps” commonly used in the art.

Downstream of the vacuum safety valve 30, a nozzle assembly 108 is connected to the vacuum hose 102d. The nozzle assembly can comprise any suitable device that enables an operator of the vacuum system to move and position the vacuum generated by the vacuum-generating device at a desired location. As depicted in FIG. 5, the nozzle assembly 108 comprises a tube section 110 and a nozzle 112. The tube section 110 of the nozzle assembly 108 can be made of any suitable material, but typically is constructed using a rigid material such as metal or plastic. The nozzle 112 can also be made of any suitable material. However, in order to lessen the risk of injury due to contact with the nozzle 112, the nozzle 112 typically is made of a semi-rigid plastic or rubber. Alternatively, the nozzle 112 can be constructed using a rigid material, such as metal or plastic, which is then covered with a cushioning material, such as rubber or foam. The nozzle assembly 108 can further comprise a nozzle handle 114 to aid in the movement and positioning of the nozzle assembly 108 during the excavation of debris or soil.

The vacuum safety valve and vacuum nozzle system of the invention can be used for any suitable purpose. For example, the vacuum safety valve and vacuum nozzle system of the invention are particularly useful in the removal of debris or soil from an excavation site. In particular, the vacuum safety valve and vacuum nozzle system can be used to remove debris or soil from a desired site in order to excise an object or victim (e.g., human victim) that is partially covered by the debris or soil. During such use, the vacuum safety valve of the invention helps to insure that the relatively large vacuum force needed to remove the debris or soil does not harm the object or victim. More specifically, as noted above, the design of the vacuum safety valve of the invention is such that the safety valve is tripped from a first, closed position to a second, vented position when the pressure within the vacuum system falls below a specified level. The reduction in pressure within the vacuum system can be induced by a blockage within the hoses of the system, or it can be induced by an object or victim contacting and substantially or completely blocking the inlet for the vacuum system. When the vacuum safety valve of the invention is tripped over to the second, vented position, at least one radial port on the vacuum safety valve is opened and the internal chamber of the vacuum safety valve can communicate with the environment surrounding the safety valve, thereby increasing the pressure within the vacuum system to a level that will permit removal of the blockage.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vacuum safety valve for a vacuum system, the vacuum safety valve having a circumference and comprising
an internal chamber, the internal chamber being adapted to communicate with a vacuum system, and
at least one selectively openable radial port, the radial port being positioned at a point on the circumference of the safety valve,
wherein the safety valve is adapted to automatically open the at least one radial port when the vacuum within the safety valve rises above a predetermined vacuum level, the predetermined vacuum level being indicative of a blockage of the airflow path in a vacuum system comprising the safety valve.

2. The vacuum safety valve of claim 1, wherein the opening of the at least one radial port causes a section of the safety valve to be about 50% open to airflow from an environment surrounding the safety valve.

3. The vacuum safety valve of claim 1, wherein the opening of the at least one radial port is brought about by mechanical pressure release.

4. A vacuum system comprising the vacuum safety valve of claim 1 and at least one vacuum hose, the vacuum hose comprising an outer wall and an internal canal and being connected to the vacuum safety valve so that the internal chamber of the safety valve communicates with the internal canal of the vacuum hose.

5. A vacuum safety valve for a vacuum system, the safety valve having a circumference and comprising
an inner sleeve comprising at least one airflow passageway and an internal channel, the internal channel being adapted to communicate with a vacuum system,
an outer sleeve comprising at least one airflow passageway, the outer sleeve being positioned to surround at least a portion of the inner sleeve and adapted to permit telescopic movement of the inner sleeve within the outer sleeve, the outer sleeve and inner sleeve being further adapted to assume at least a first position and second position, the airflow passageway of the inner sleeve being at least substantially blocked by the outer sleeve in said first position, and the airflow passageways of the outer sleeve and inner sleeve being substantially aligned to form at least one radial port in said second position, and
a retainer assembly, the retainer assembly being positioned to contact at least one of the inner and outer sleeves and being adapted to retain the inner and outer sleeves in said first position, the retainer assembly being further adapted to permit the inner and outer sleeves to move to said second position when the vacuum within the safety valve rises above a predetermined vacuum level.

6. The vacuum safety valve of claim 5, wherein the predetermined vacuum level is indicative of a blockage of the airflow path in a vacuum system comprising the safety valve.

7. The vacuum safety valve of claim 5, wherein the safety valve further comprises a safety screen, the safety screen being positioned around the circumference of the safety valve and covering at least a portion of the outer sleeve comprising the airflow passageway.

8. The vacuum safety valve of claim 5, wherein the outer sleeve further comprises at least one port, the port being positioned at a distal end of the outer sleeve and being adapted to communicate with the environment surrounding the safety valve.

9. The vacuum safety valve of claim 8, wherein the safety valve further comprises a manual vacuum relief assembly.

10. The vacuum safety valve of claim 9, wherein the manual vacuum relief assembly comprises a plug, the plug being positioned above the port of the outer sleeve and adapted to sealingly engage the port to prevent airflow into the port from an environment surrounding the safety valve, the plug being further adapted to disengage from the port upon application of a force to the plug.

11. The vacuum safety valve of claim 5, wherein the inner sleeve has an outer surface and the outer sleeve has an inner surface, at least a portion of the outer surface of the inner sleeve confronting the inner surface of the outer sleeve, and the retainer assembly being positioned to contact said outer surface of the inner sleeve.

12. The vacuum safety valve of claim 11, wherein the inner sleeve further comprises a groove on the outer surface of the inner sleeve, and the retainer assembly is positioned to engage the groove when the inner and outer sleeves are in the first position.

13. The vacuum safety valve of claim 12, wherein the retainer assembly comprises a nylon spring plunger.

14. The vacuum safety valve of claim 5, wherein the safety valve further comprises a cylindrical tube comprising a cylindrical channel therein, the cylindrical tube being positioned substantially perpendicular to the inner sleeve and adapted to permit airflow communication between the cylindrical channel and the internal channel of the inner sleeve.

15. A vacuum system comprising the vacuum safety valve of claim 5 and at least one vacuum hose, the vacuum hose comprising an outer wall and an internal canal and being connected to the safety valve so that the internal chamber of the safety valve communicates with the internal canal of the vacuum hose.

16. A vacuum system comprising the vacuum safety valve of claim 13 and at least one vacuum hose, the vacuum hose comprising an outer wall and an internal canal and being connected to the safety valve so that the internal chamber of the safety valve communicates with the internal canal of the vacuum hose.

17. A vacuum system comprising the vacuum safety valve of claim 14 and at least one vacuum hose, the vacuum hose comprising an outer wall and an internal canal and being connected to the cylindrical tube so that the cylindrical channel and the internal chamber of the safety valve communicate with the internal canal of the vacuum hose.

18. The vacuum system of claim 15, wherein the vacuum system further comprises a nozzle assembly, the nozzle assembly being connected to the vacuum hose.

19. A method for removing material from an excavation site, the method comprising the steps of
(a) providing an excavation site,
(b) providing the vacuum system of claim 4,
(c) applying a vacuum to the vacuum system such that the pressure within the vacuum system is reduced and gases from an environment surrounding the vacuum system flow into the vacuum system, and
(d) positioning the vacuum system such that the gases flowing into the vacuum system convey at least a portion of the material into the vacuum system to remove the material from the excavation site.

20. A method for removing material from an excavation site, the method comprising the steps of
(a) providing an excavation site,
(b) providing the vacuum system of claim 15,
(c) applying a vacuum to the vacuum system such that the pressure within the vacuum system is reduced and gases from an environment surrounding the vacuum system flow into the vacuum system,
(d) positioning the vacuum system such that the gases flowing into the vacuum system convey at least a portion of the material into the vacuum system to remove the material from the excavation site.
